(19) United States
(12) Patent Application Publication
(10) Pub. No.: US 2011/0087452 A1
(43) Pub. Date: Apr. 14, 2011

(54) TEST DEVICE

(75) Inventors: Shih-Wai Huang, Taoyuan County (TW); Te-Hsin Chen, Taipei County (TW); Chih-Hua Ho, Taipei County (TW); Ming-Ying Yen, Tainan City (TW)

(73) Assignee: Quanta Computer Inc., Taoyuan Shien (TW)

(21) Appl. No.: 12/767,446

(22) Filed: Apr. 26, 2010

(30) Foreign Application Priority Data
Oct. 12, 2009 (TW) 98134528

(51) Int. Cl. G06F 19/00

(52) U.S. Cl. 702/117

(57) ABSTRACT

A test device for testing a system, which has first interface circuit, second interface circuit, and a power switch, comprises a power supply, status detector, and a controller. The power supply includes a supplying unit and a switch controller. The supplying unit provides a test power signal according to a wall wart signal. The switch controller enables the power switch to power the system with the test power signal in response to a control signal. The system boots according to operation system data provided via first interface circuit in response to the test power signal. The status detector generates a status detection signal indicating whether the system boots up successfully in response to an operation signal on the second interface circuit. The controller provides the control signal and processes the status detection signal.

This application claims the benefit of Taiwan application Serial No. 98134528, filed Oct. 12, 2009, the subject matter of which is incorporated herein by reference.

### BACKGROUND OF THE INVENTION

1. Field of the Invention

The invention relates in general to a test device, and more particularly to a test device for testing the mainboard of a computer system.

2. Description of the Related Art

During the stage of system development, the research and development personnel need to clearly understand whether the related circuits of the power of the computer system are stable to assure the normal operation of the circuits and chips in the system. In general, the research and development personnel need to perform operations such as AC cycling test mode or DC cycling test mode (shutdown, cold Boot and DC on/off) on the computer system to verify whether the related circuits of the power of the computer system are stable. However, if the above operations are performed manually, a large amount of labor and time will be needed and at the same time manual operations will lead to the problems such as high testing accuracy and testing stability. Therefore, how to develop devices capable of effectively performing the above operations on a computer system has become a prominent task for the industries.

### SUMMARY OF THE INVENTION

The invention is directed to a test device, which is programmed to perform tests, such as AC cycling test mode or DC cycling test mode (shutdown, cold Boot and DC on/off), on a system. In comparison to the conventional test devices of a computer system, the related test devices of the invention effectively avoid performing the above operations manually, and are advantageously manufactured with fewer labor, lower cost, and high testing accuracy and testing stability.

According to an aspect of the present invention, a test device for testing a system is provided. The system includes a first interface circuit, a second interface circuit and a power switch. The test device includes a power supply, a status detector and a controller. The power supply includes a supplying unit and a switch controller. The supplying unit provides a test power signal according to a wall wart signal. The switch controller periodically enables the power switch to power the system with the test power signal in response to the control signal. The system is enabled in response to the test power signal and boots up according to an operation system data provided via the first interface circuit. The status detector is coupled to the second interface circuit for generating a status detection signal indicating whether the system boots up successfully in response to an operation signal on the second interface circuit. The controller provides the control signal and processes the status detection signal provided by the status detector.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a test device according to an embodiment of the invention;

FIG. 2 shows a detailed block diagram of the supplying unit 11a of FIG. 1;

FIG. 3 shows a detailed block diagram of the switch controller 11b of FIG. 1;

FIG. 4 shows a detailed block diagram of the status detector 12 of FIG. 1;

FIG. 5 shows a detailed block diagram of the switch controller 13 of FIG. 1;

FIGS. 6, 7, 8, 9, 10A, 10B, 11A and 11B respectively show the flowcharts of the test operations performed by the embedded system ES of FIG. 5; and

FIG. 12 shows another block diagram of the test device according to an embodiment of the invention.

### DETAILED DESCRIPTION OF THE INVENTION

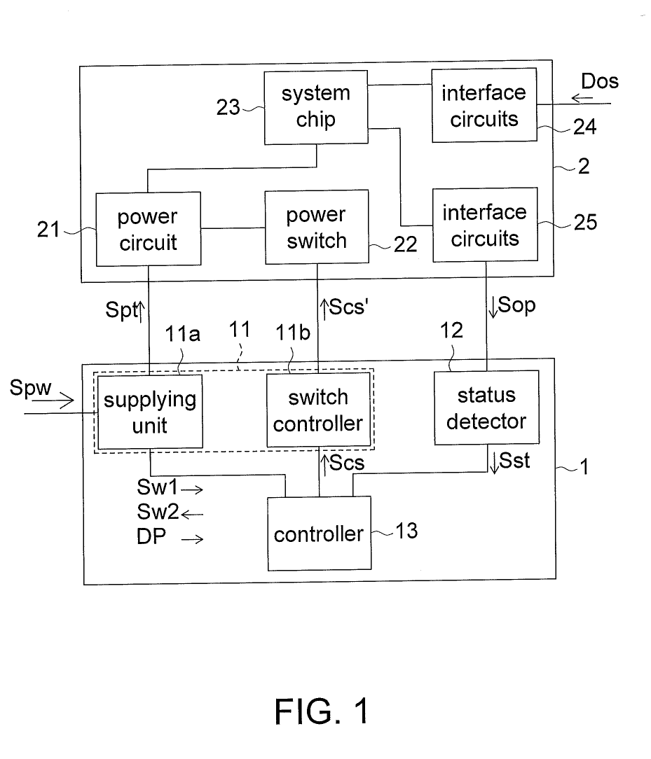

Referring to FIG. 1, a block diagram of a test device according to an embodiment of the invention is shown. The test device 1 is used for performing tests such as AC cycling test mode or DC cycling test mode (shutdown, cold Boot and DC on/off) on a system 2. For example, the test device 1 is a mainboard test stand, and the system 2 is a to-be-tested mainboard having a power circuit 21, a power switch 22, a system chip 23, and two interface circuits 24 and 25 disposed thereon.

The interface circuits 24 and 25 are, for example, controlled by the system chip 23. For example, the interface circuit 24 could be a universal serial bus (USB) interface circuit or a network controller (NIC) for receiving an operating system (OS) data Dos provided by an external circuit. For example, the interface circuit 25 could be a USB interface circuit, a video graphic array (VGA) interface circuit or an NIC, which are controlled by the system chip 23 for performing corresponding interface transmission.

During the test operation, the to-be-tested mainboard could further have a central processing unit (CPU) and a random access memory (RAM) disposed thereon. There is a corresponding communication link between the system chip 23 and the CPU and the RAM for forming a complete computer system. Thus, the system 2 could shut down or boot up according to the operation system data Dos provided by the interface circuit 24 in response to the power signal and the switch control signal provided by the test device 1.

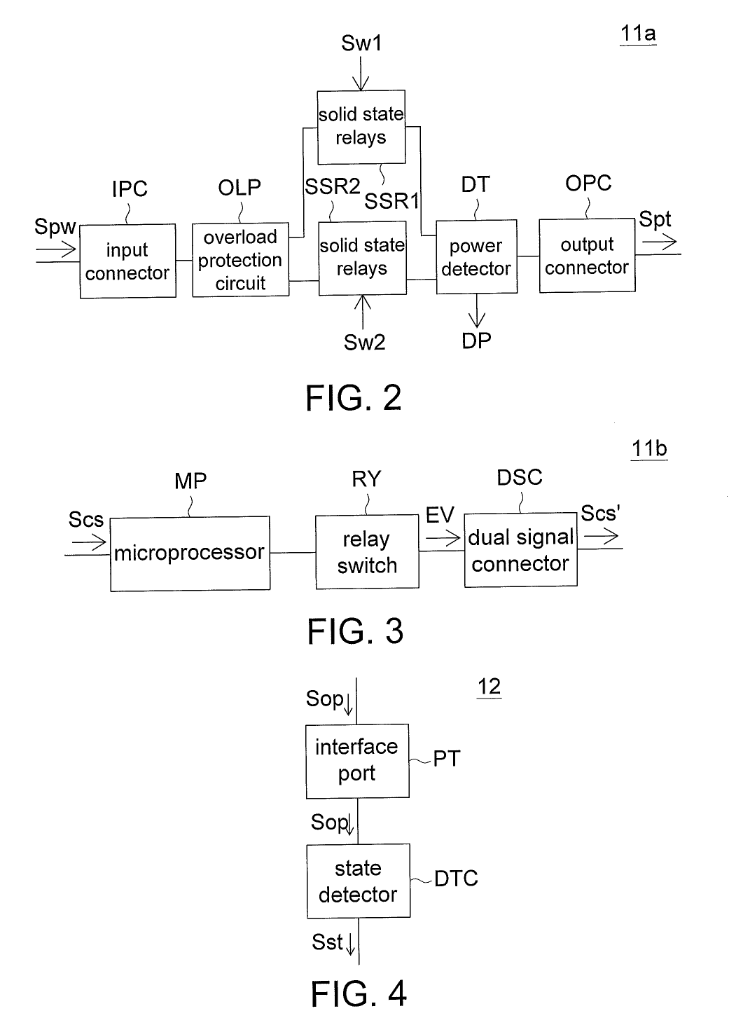

The test device 1 includes a power supply 11, a status detector 12 and a controller 13. The power supply 11 includes a supplying unit 11a and the switch controller 11b. The supplying unit 11a provides a test power signal Spt in response to a wall wart signal Spw. For example, the supplying unit 11a includes an input connector IPC, an overload protection circuit OLP, two solid state relays SSR1 and SSR2, a power detector DT and an output connector OPC, as indicated in FIG. 2.

The input connector IPC, such as a 220V male connector, is used for receiving a voltage such as the 220V wall wart signal Spw. The solid state relays SSR1 and SSR2, under the control of the control signals SW1 and SW2 provided by the controller 13, selectively switch the wall wart signal via the overload protection circuit OLP for selectively closing the power signal transmission path. Since two solid state relays SSR1 and SSR2 are employed in the supplying unit 11a, the supplying unit 11a could simultaneously open or close the live line and the neutral line on the power signal transmission path. The power detector DT is used for detecting the power signal provided by the solid state relays SSR1 and SSR2 and further records and outputs related electric signal parameter data DP (examples of the basic electric signal parameters include voltage, current, and power) to the controller 13. The output connector OPC is used for outputting the test power signal Spt to the system 2 according to the power signal.

The switch controller 11b periodically provides a switch signal Scs′ for enabling the power switch 22 to power the system 2 with a test power signal Spt in response to the control signal Scs. For example, the switch controller 11b includes a microprocessor MP, a relay switch RY and a dual signal connector DSC as indicated in FIG. 3. The microprocessor MP is used for receiving and outputting the control signal Scs provided by the controller 13. The relay switch RY, under the control of the microprocessor MP, activates the circuit event EV for simulating the event that the power button is pressed. The dual signal connector DSC provides the control signal Scs′ to the power switch 22 of the system 2 so as to control the power switch 22 in response to the circuit event EV.

The status detector 12 is coupled to the interface circuit 25 for generating a status detection signal Sst indicating whether the system 2 boots up successfully in response to an operation signal Sop on the interface circuit 25. For example, the status detector 12 includes an interface port PT and a state detector DTC as indicated in FIG. 4. The interface port PT is connected to the interface circuit 25 of the system 2 via a corresponding communication link.

For example, the interface circuit 25 is a USB connector, so that when the system 2 finishes booting, the interface circuit 25 will correspondingly have a USB operation signal (such as a D+, D−, a power signal VDD or a ground signal GND). The interface port PT receives and further provides a USB operation signal (that is, the operation signal Sop) to the detector DTC. The detector DTC determines whether the USB signal is received. If so, the detector DTC generates a status detection signal Sst indicating the system 2 finishes booting.

For example, the detector DTC could include a power sensor (not illustrated) which determines whether a power signal of the USB operation signal is received for correspondingly determining whether the system 2 finishes booting. For example, the detector DTC further includes a keyboard simulator (not illustrated) for simulating a keyboard being connected to the system 2 via the SUB cable and the interface circuit 25.

In another example, the interface circuit 25 is a VGA interface circuit, so that when the system 2 finishes booting, the interface circuit 25 will correspondingly provide a video signal (such as corresponding to the pixel data of a plurality of pixels). The interface port PT is such as a D-subminiature (D-sub) visual interface port or a digital visual interface (DVI) port for receiving and providing a video signal (that is, the operation signal Sop) to the detector DTC. Thus, the detector DTC could correspondingly provide a status detection signal Sst indicating whether the system 2 finishes booting.

For example, the status detector 12 could also have another interface port (not illustrated) for receiving and outputting the operation signal Sop provided by the interface port PT to a corresponding output device such as a display. Thus, the user could also view related frames via the display when the system 2 boots up.

In yet another example, the interface circuit 25 is an NIC, and the test device 1 could also have a corresponding status detector 12 for detecting the operation signal of related networks and corresponding providing a status detection signal Sst indicating the booting state of the system 2.

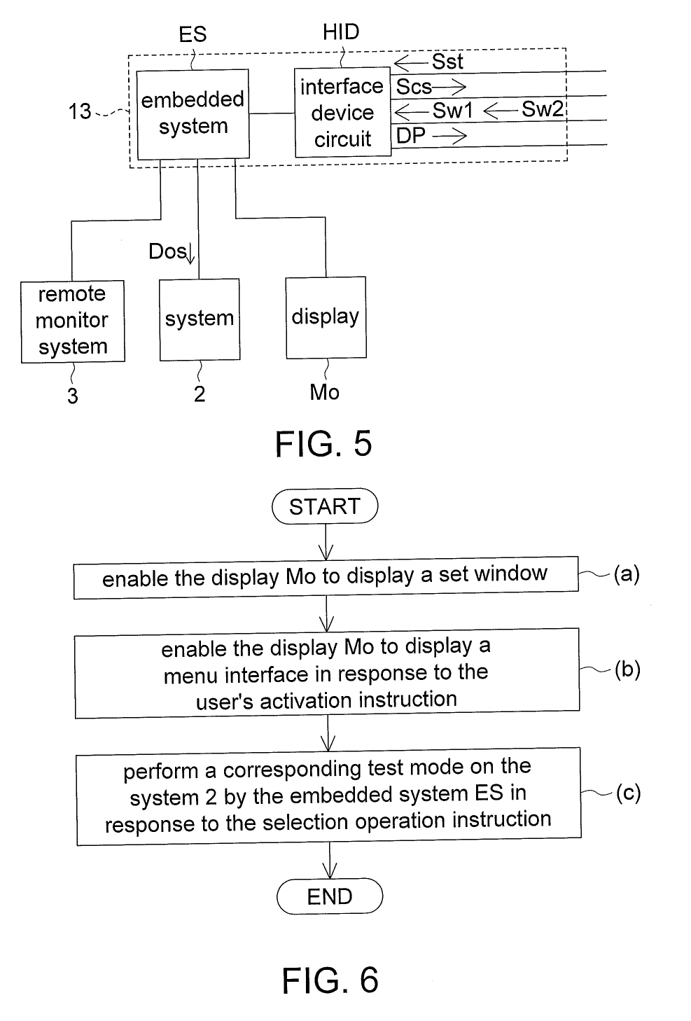

The controller 13 provides a control signal Scs to the switch controller 11b and processes the status detection signal Sst provided by the status detector 12. For example, the controller 13 includes an interface device circuit HID and an embedded system ES as indicated in FIG. 5. The interface device circuit HID has a corresponding port for transmitting such as the control signals SW1 and SW2, the control signal Scs, the related electric signal parameter data DP and the status detection signal Sst.

The embedded system ES performs corresponding software to generate the control signals SW1 and SW2 and the control signal Scs and processes the control signal, the status detection signal Sst and the related electric signal parameter data DP to generate a test data. In an example, the embedded system ES further includes an image output interface circuit (not illustrated) for outputting the test data to a corresponding display Mo, which displays the test data accordingly. Thus, the user can effectively view the control signals SW1 and SW2, the control signal Scs, the status detection signal Sst and the related electric signal parameter data DP via the test device 1.

In an example, the embedded system ES further includes an NIC (not illustrated) and a network activating server function module, wherein the NIC is such as connected to the interface circuit 24 of the system 2 via a network path. For example, the network activating server function module such as supports an intelligent platform management interface (IPMI) instruction, or remote boots up the system 2 via a part of or all of the preboot execution environment (PXE), the dynamic host configuration protocol server (DHCP), and the trivial file transfer protocol (TFTP).

In an example, the embedded system ES further has a state upload module (not illustrated), and could be connected to a remote monitor system 3 via the NIC, so as to transmit the test data to the remote monitor system 3. Thus, with the remote monitor system 3, the user can remotely monitor the test operation performed by the test device 1.

In an example, the embedded system ES further has a part of or all of the functions (for administrating and inspecting the system state of the test device 1) including quickly boot, system partition write protection, operation system automatically update and remote web-based management to facilitate the user in the test operation.

Referring to FIG. 6, a flowchart of the test operation performed by the embedded system ES is shown. For example, the embedded system ES can perform an interface menu for allowing the user to selectively control the test device 1 to perform different test modes on the system 2. Firstly, the test operation begins at step (a), the embedded system ES enables the display Mo to display a set window, wherein the display Mo is such as a touch display. Next, the test operation proceeds to step (b), the display Mo activates an operation instruction in response to the user's touch operation, and the embedded system ES enables the display Mo to display a menu interface in response to the activation instruction. Via the menu interface, the user can selectively enable the test device 1 to perform a part or all of the test modes for performing corresponding test operations on the system 2. Then, the test operation proceeds to step (c), the display Mo generates a selection operation instruction in response to the user's touch operation, and the embedded system ES performs a corresponding test mode in response to the selection operation instruction to perform corresponding test operations on the power the system 2.

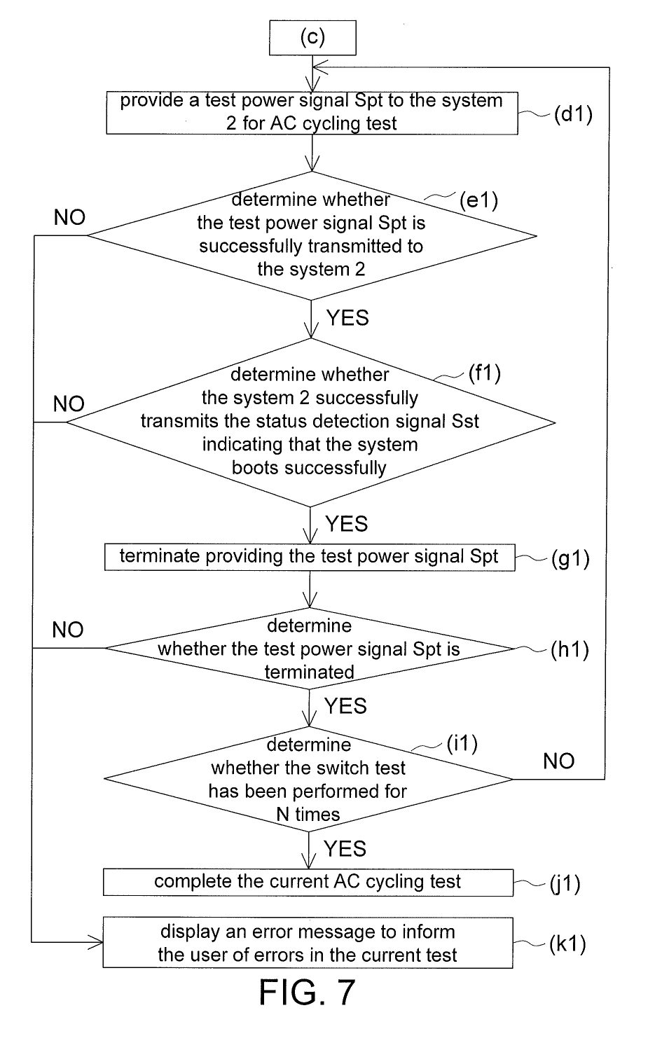

In an example, the test device 1 can support the operation modes such as AC cycling test mode, DC cycling test mode (shutdown, cold boot, and DC on/off), remote boot test mode, AC/DC cycling test mode, and remote boot test mode. For example, the operation procedures of AC power switch are illustrated in FIG. 7.

Firstly, the test operation begins at step (d1), the test device 1 provides a test power signal Spt (such as an AC power signal) to the system 2 via a supplying unit 11a. Next, the test operation proceeds to step (e1), the test device 1 determines whether the test power signal Spt is successfully transmitted to the system 2. If so, the procedure proceeds to step (f1), the test device 1 determines whether the system 2 successfully transmits the status detection signal Sst indicating that the system boots successfully. If so, the procedure proceeds to step (g1), the test device 1 turns off the supplying unit 11a to terminate providing the test power signal Spt. Then, the procedure proceeds to step (h1), the test device 1 determines whether the test power signal Spt is terminated. If so, the procedure proceeds to step (i1), the test device 1 determines whether the switch test has been performed for N times, wherein N is the number of test operations set by the user. If so, the procedure proceeds to step (j1), the test device 1 determines that the current AC cycling test is completed. If not, steps (d1)-(j1) are repeated. In steps (e1) (f1) and (h1), the test device 1 respectively determines that the test power signal Spt is not successfully transmitted to the system 2, that the system 2 did not transmit the status detection signal Sst indicating the system boots up successfully, and that the test power signal Spt is not terminated, then the procedure proceeds to step (k1), the test device 1 displays an error message to inform the user of test error.

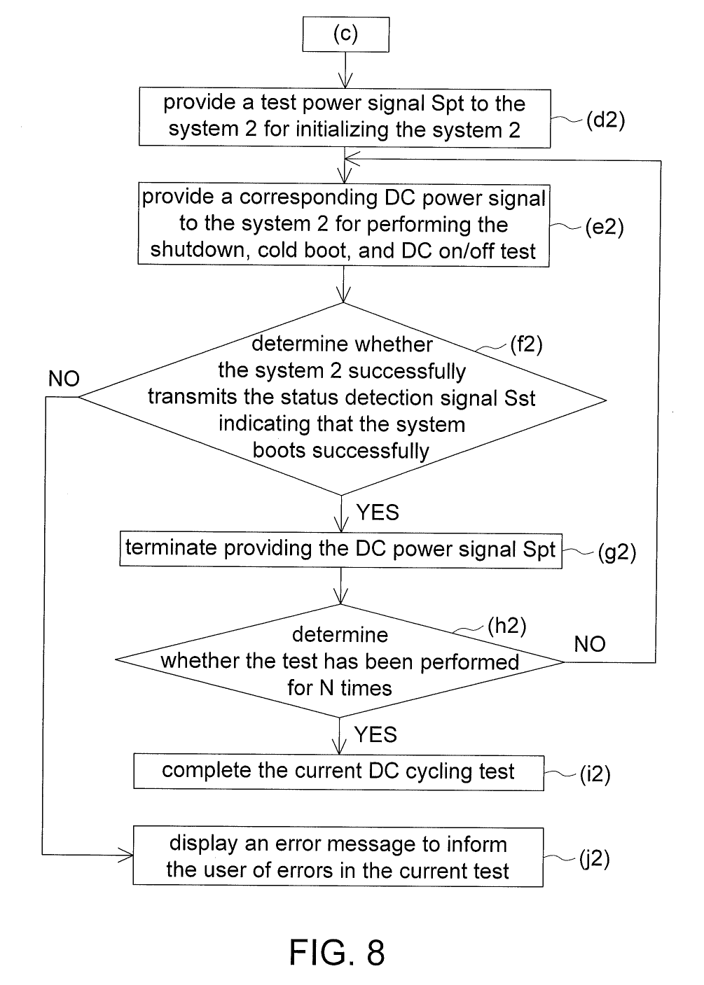

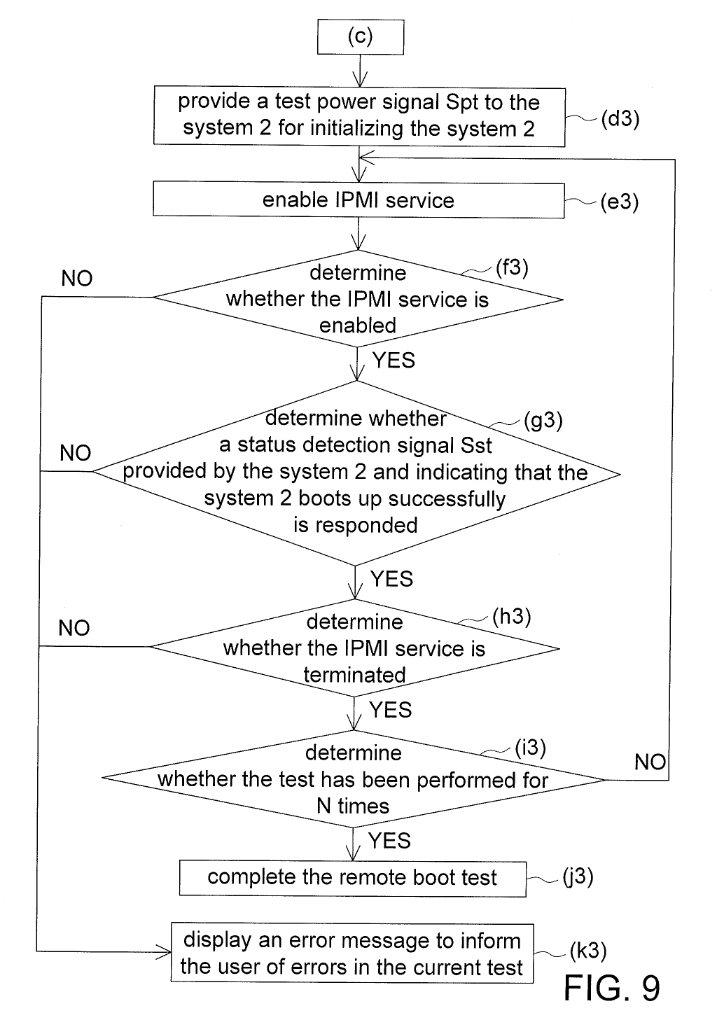

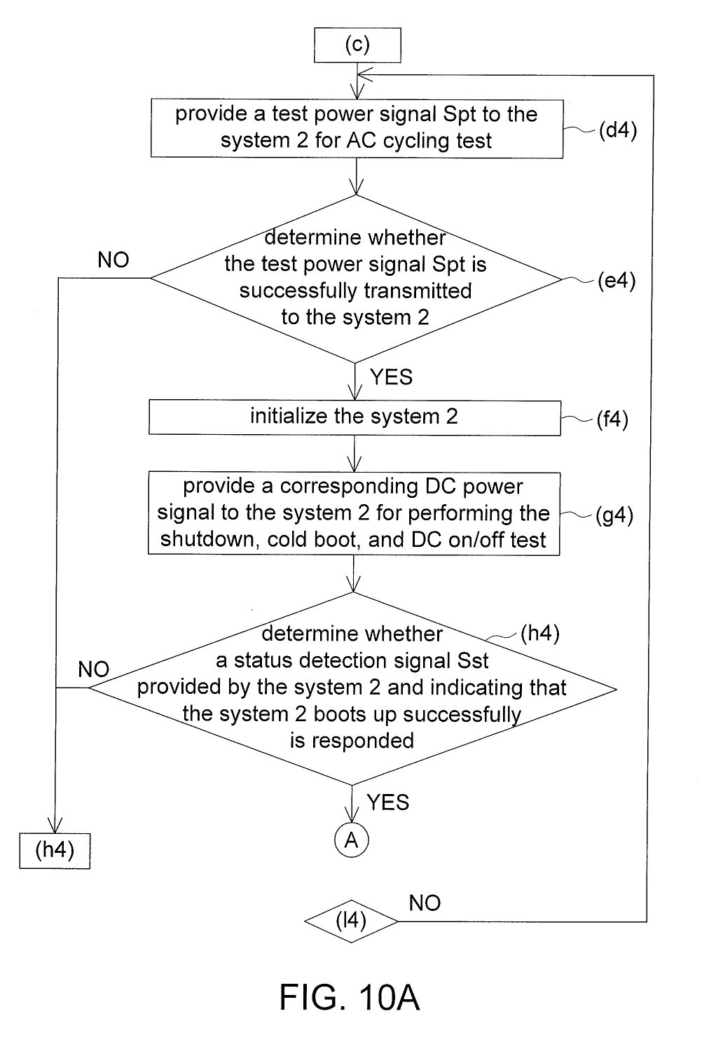

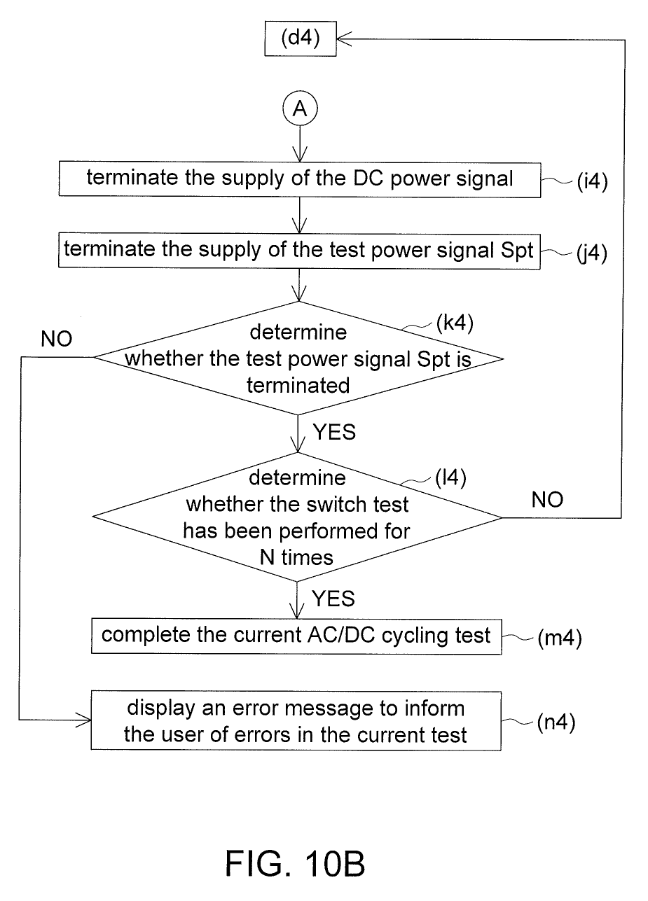

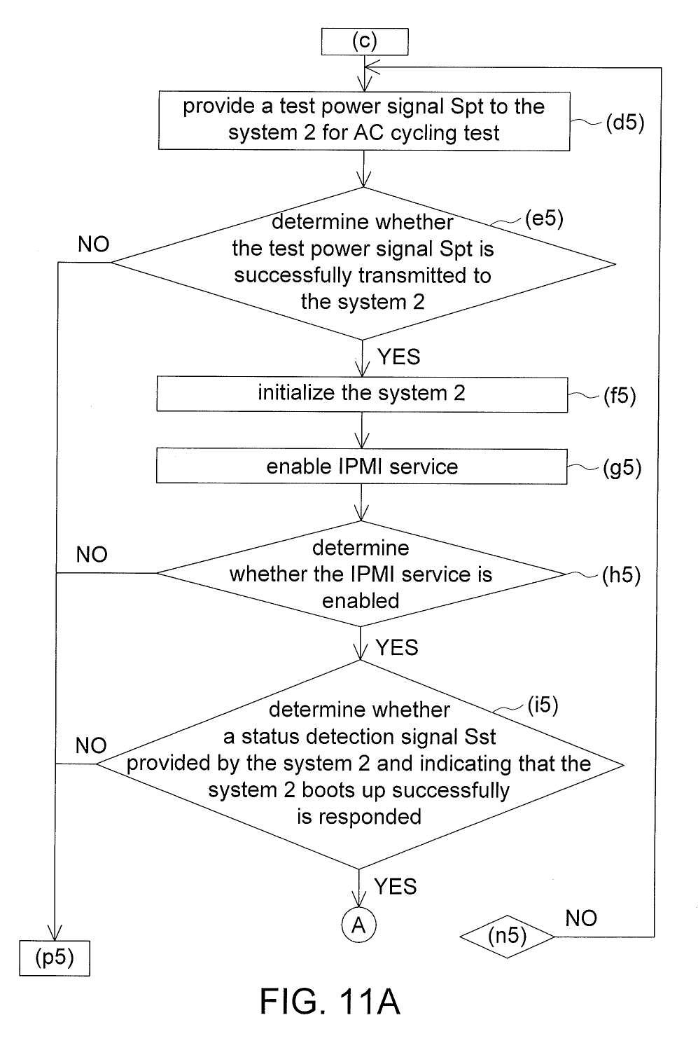

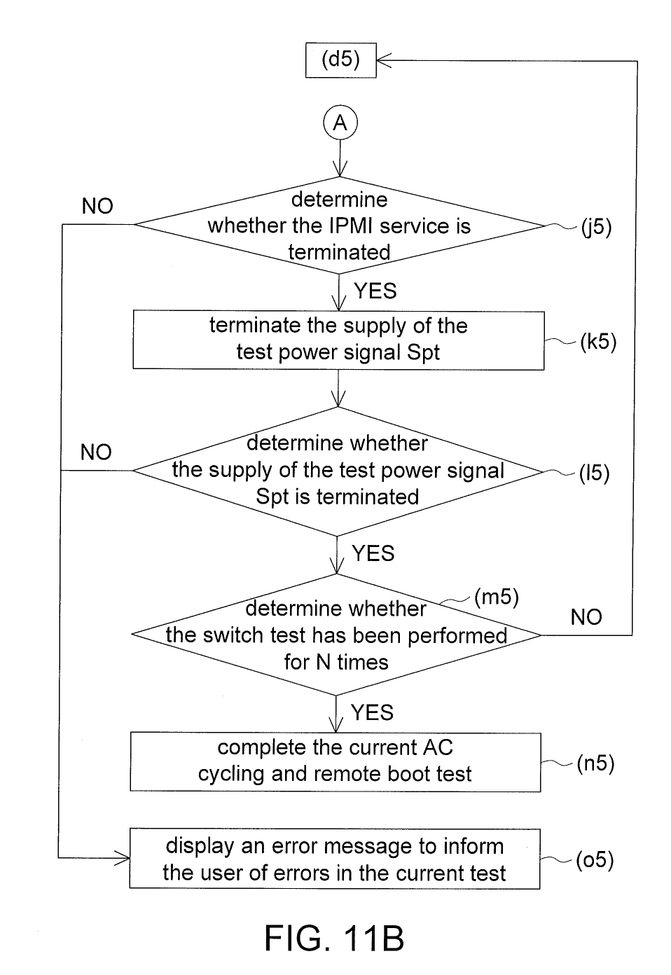

The steps of the operations of the DC cycling test mode, the remote boot test mode, the AC/DC cycling test mode and the AC cycling test mode and the remote boot test mode are respectively illustrated in FIG. 8, 9, 10A, 10B, 11A and 11B, and the detailed description of the steps of the above modes are not elaborated here.

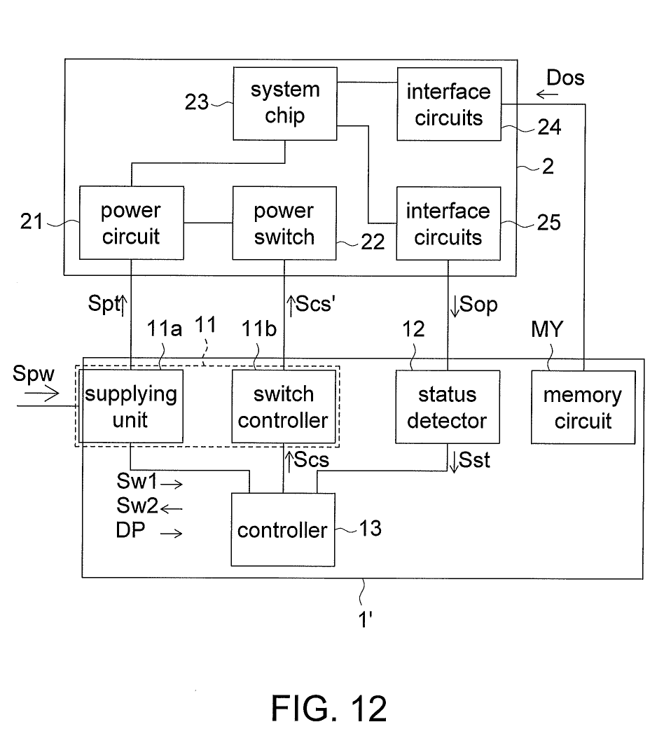

Though only the situation that the embedded system ES provides an operation system data Dos to a system 2 via a network path for enabling the system 2 to boot up with the operation system data Dos provided via the network path is illustrated as an example in the present embodiment, the test device 1 according to the present embodiment of the invention is not limited thereto. In other examples, the test device 1 could include a memory circuit MY via which a path is accessed for providing an operating system data Dos to the system 2 as indicated in FIG. 12.

The embodiment of invention is directed to a test device, which is programmed to perform various tests, such as AC cycling test mode or DC cycling test mode (shutdown, cold Boot and DC on/off), on a system. In comparison to the conventional test devices of a computer system, the related test devices of the invention effectively avoid performing the above operations manually, and are advantageously manufactured with fewer labor, lower cost, and high testing accuracy and testing stability.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A test device for testing a system comprising a first interface circuit, a second interface circuit and a power switch, wherein the test device comprises:
a power supply, comprising:
a supplying unit for providing a test power signal according to a wall wart signal; and
a switch controller for periodically enabling the power switch to power the system with a test power signal in response to a control signal, wherein the system is enabled in response to the test power signal and boots up a system according to an operation system data provided via the first interface circuit;
a status detector coupled to the second interface circuit for generating a status detection signal indicating whether the system boots up successfully in response to an operation signal on the second interface circuit; and
a controller for providing the control signal and processing the status detection signal provided by the status detector.

2. The test device according to claim 1, further comprising:
a memory circuit for storing and providing the operation system data to the system.

3. The test device according to claim 1, wherein the status detector comprises:
a connector coupled to the second interface circuit of the system via a communication link for receiving the operation signal; and
a detector for generating the status detection signal according to the operation signal.

4. The test device according to claim 1, wherein the controller comprises:
a network controller connected to the system via a network path; and
a server for providing an operation system data to the system via the network path for booting up the system.

5. The test device according to claim 1, wherein the power supply further comprises:
a power detector for detecting a plurality of related electric signal parameters related to the test power signal, wherein the power detector further provides the related electric signal parameters to the controller.

6. The test device according to claim 5, wherein the controller further comprises:
a processing circuit for generating the control signal and processing the control signal, the status detection signal and the related electric signal parameters so as to generate a test data.

7. The test device according to claim 6, wherein the controller further comprises:
a network controller connected to a remote control system via a network path; and
a state upload module for transmitting the test data to the remote control system via the network path.
